(19) United States
(12) Patent Application Publication
(10) Pub. No.: US 2013/0229010 A1
(43) Pub. Date: Sep. 5, 2013

(54) ASSEMBLY WITH SEALING GASKETS HAVING LOCKING INSERTS

(71) Applicants: Alain Percebois, Blenod Les Pont-A-Mousson (FR); Francois Maire, Vandieres (FR); Patrick Joly, Bainville Sur Madon (FR); Christian Eugene, Bouxieres Sous Froidmont (FR)

(72) Inventors: Alain Percebois, Blenod Les Pont-A-Mousson (FR); Francois Maire, Vandieres (FR); Patrick Joly, Bainville Sur Madon (FR); Christian Eugene, Bouxieres Sous Froidmont (FR)

(73) Assignee: Saint-Gobain Pam, Nancy (FR)

(21) Appl. No.: 13/881,348

(22) PCT Filed: Oct. 25, 2011
(86) PCT No.: PCT/FR2011/052488

§ 371 Date: Apr. 24, 2013

(30) Foreign Application Priority Data
Oct. 26, 2010 (FR) 1058776

(51) Int. Cl. F16L 21/03

(52) U.S. Cl. CPC F16L 21/03
USPC 285/81

(57) ABSTRACT

This assembly between a spigot and a socket comprises a sealing gasket provided with a locking insert which comprises a head and a foot. The head comprises a radial projection, designed to press against a bottom surface of an anchoring groove belonging to the socket and a first inclined projection, designed to press against an inclined surface of the anchoring groove. The head also comprises a frontal projection which is offset from the first inclined projection and designed to press against an annular frontal surface of the anchoring groove. Application to the connecting of cast iron pipes.

The present invention relates to a sealed and locked assembly, of the type comprising a spigot of a first pipe element, a socket of a second pipe element, and a composite sealing gasket for the sealed and locked assembly between the spigot and the socket, the sealing gasket comprising a ring made from an elastic material that extends along the central axis (X-X), and which has a body and an anchoring heel on the one hand, and at least one locking insert at least partially embedded in the anchoring heel on the other hand,

the socket comprising an annular anchoring groove, the anchoring groove being defined by an inclined surface positioned axially and radially between a bottom surface and an annular frontal surface,

the locking insert comprising,
a head suitable for being inserted into the anchoring groove of the socket, and a foot,

the head including a radial projection, designed to press against the bottom surface of the anchoring groove of the socket and a first inclined projection, suitable for pressing against the inclined surface of the anchoring groove.

It in particular applies to sealed and locked assemblies for two cast-iron pipes.

Document EP-A-526 373 describes a sealing gasket comprising a sealing body and an anchoring heel made from an elastic material as well as a plurality of locking inserts made from a rigid material embedded in the anchoring heel. Each insert has an anchoring head designed to bear on the bottom of an anchoring groove formed in a socket, as well as catching teeth capable of engaging in the outer surface of a spigot so as to prevent axial movements that could separate the spigot from the socket under the action of the axial forces created by the pressure of the fluid circulating through the spigot and the socket.

The incline of each locking insert depends on the play between the outer diameter of the spigot and the inner diameter of the socket. The attachment of the insert on the spigot causes a reaction force whereof the incline angle on the median direction varies as a function of the play present between the assembled ends.

The higher this reaction angle, measured relative to the radial direction, the more the locking withstands the inner pressure of the fluid circulating through the assembly. Conversely, the attachment of the inserts in the outer surface of the spigot is better when the reaction angle is low. In fact, if the angle is too large, the teeth of the inserts risk not catching the spigot during pressurization, and sliding thereon, causing deficient locking.

The risk of poor resistance to pressure is critical toward the maximum plays where the reaction angle is naturally small, while the risk of having poor catching of the inserts is critical toward the minimal plays where that reaction angle is naturally large.

Consequently, the position of the locking insert relative to the spigot and the socket must be defined by any play allowed by manufacturing allowances between the anchoring groove and the spigot. However, the known locking junction limits the manufacturing allowances on the inserts and the anchoring groove of the socket. In fact, depending on the play present, the locking insert may assume a configuration in which it presses flat on the bottom surface of the anchoring groove or on the inclined surface connecting the bottom surface and the front surface. In the case where these surfaces include protrusions, the orientation of the insert relative to the socket is disrupted, leading to poor locking of the junction. Removing the protrusions is, however, costly.

One aim of the invention is therefore to design a locking insert and a corresponding junction that allow good catching over a wide range of plays, while having a low manufacturing cost.

Another aim of the invention is to optimize the compromise between the catching reliability of the insert on the spigot and the pressure resistance of the locking.

To that end, the invention relates to an assembly as indicated above, characterized in that the head comprises at least one frontal projection that is offset, radially, from the first inclined projection and designed to press against the annular frontal surface of the anchoring groove, the annular frontal surface and the inclined surface forming an angle smaller than 180° between them.

According to particular embodiments, the assembly comprises one or more of the following features:
the head comprises at least one second inclined projection, which is offset, in particular radially, from the first inclined projection and the frontal projection and designed to press against the inclined surface of the anchoring groove;
the first and second inclined projections are, in side view, connected by a concave or rectilinear profile;
the frontal projection and the inclined projection adjacent to the frontal projection are, in side view, connected by a concave or rectilinear profile;
in side view, the foot of the insert comprises at least one catching tooth adapted to catch on an outer surface of the spigot;
the frontal projection and the closest catching tooth are, in side view, made by a concave or rectilinear profile;
in side view, the head includes a catching nose, a first straight line extending from the radial projection toward the catching nose and a second straight line connecting the frontal projection to the first inclined projection, and the angle between said two straight lines is comprised between 60° and 120° and preferably smaller than 90°;
the head is a radially outer head, at least partially embedded in the anchoring heel and designed to press in the anchoring groove of the socket, and the foot is a radially inner foot, designed to press against the spigot;
the bottom surface that defines the annular anchoring groove is a cylindrical surface, in particular extending coaxially relative to the central axis (X-X), and the annular frontal surface is formed by an inlet flange of the socket, the annular frontal surface extending over an angle of at least 80° relative to the central axis (X-X); and
the inclined surface has an incline comprised between 30° and 60° relative to the central axis (X-X);
all of the projections are arranged such that for any diameter of the bottom surface of the socket and the outer surface of the spigot comprised in an allowance range and in a meridian cross-sectional view, the locking insert bears at the same time on at most three or two locations of the anchoring groove of the socket.

The invention will be better understood upon reading the following description, provided solely as an example and done in reference to the appended drawings, in which:

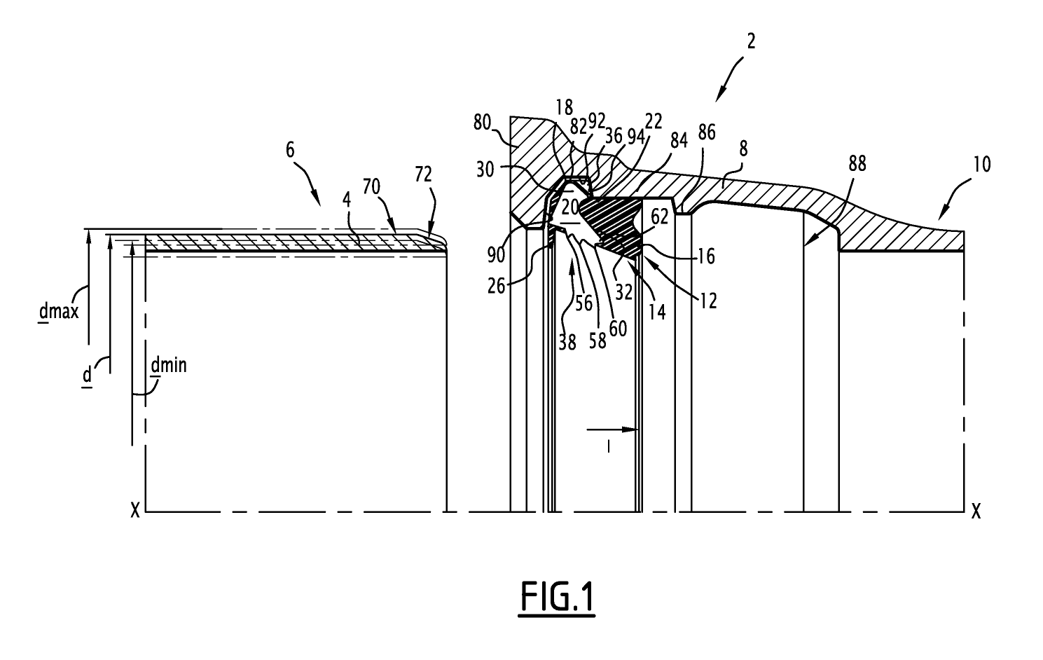

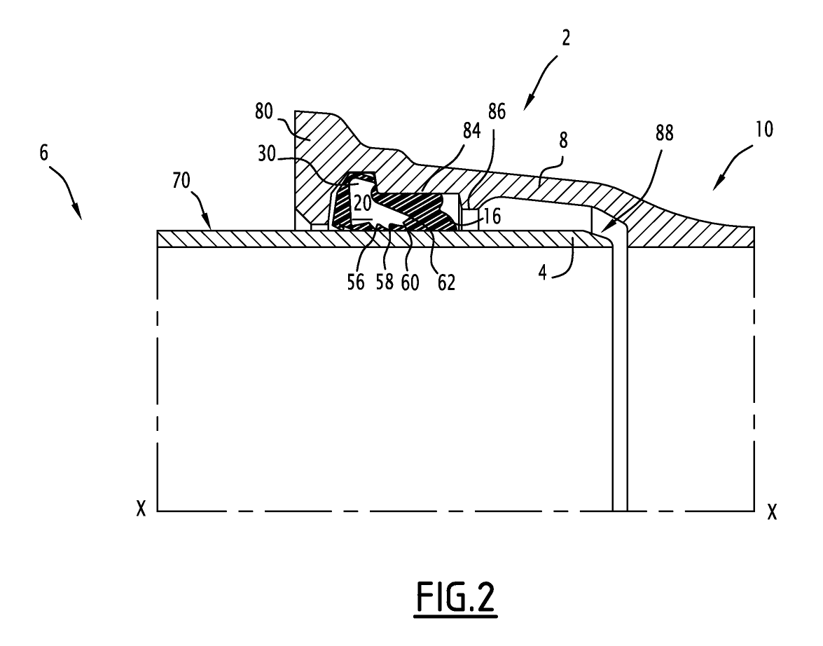

FIGS. 1 to 3 are meridian cross-sectional half-views of an assembly of two pipes and a composite sealing gasket inserted between them, respectively before, during and after production of the locked assembly according to the invention;

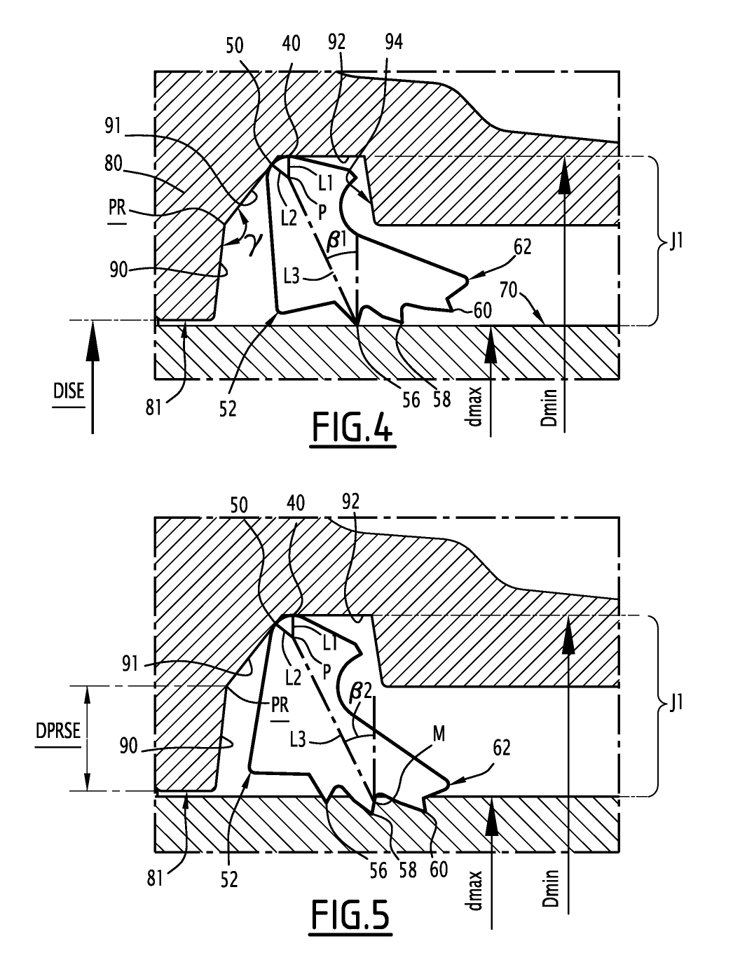

FIGS. 4 and 5 are enlarged meridian cross-sectional views of part of the assembly according to the invention during different assembly steps, the socket and the spigot defining a minimum play between them;

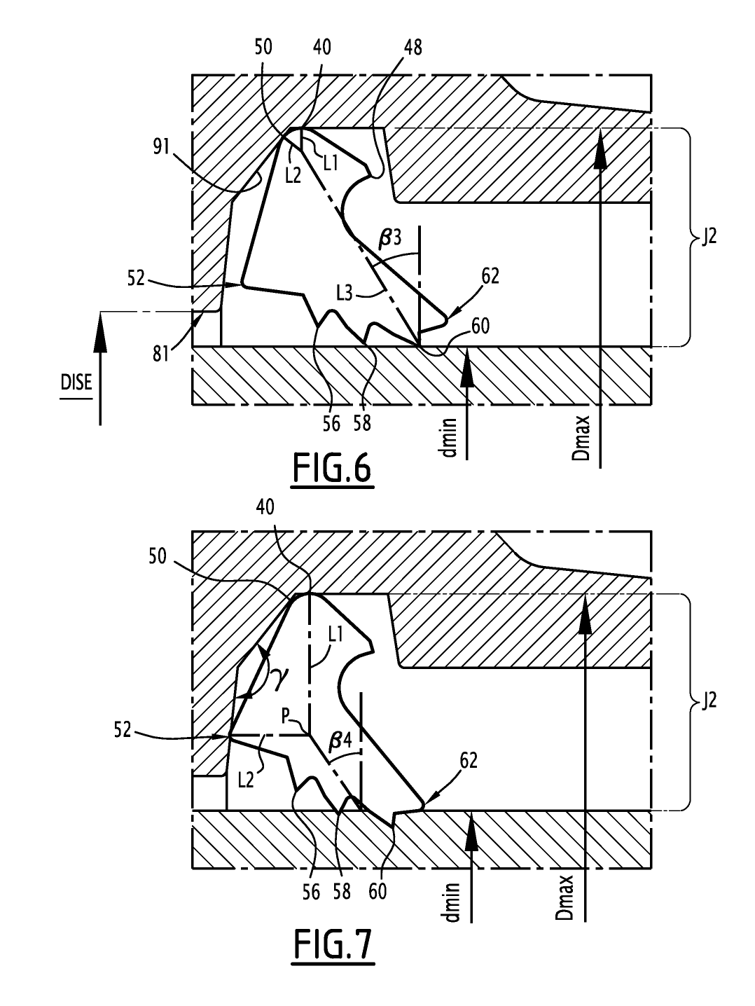

FIGS. 6 and 7 are enlarged meridian cross-sectional views of part of the assembly according to the invention in different assembly steps, the socket and the spigot defining a maximum play between them;

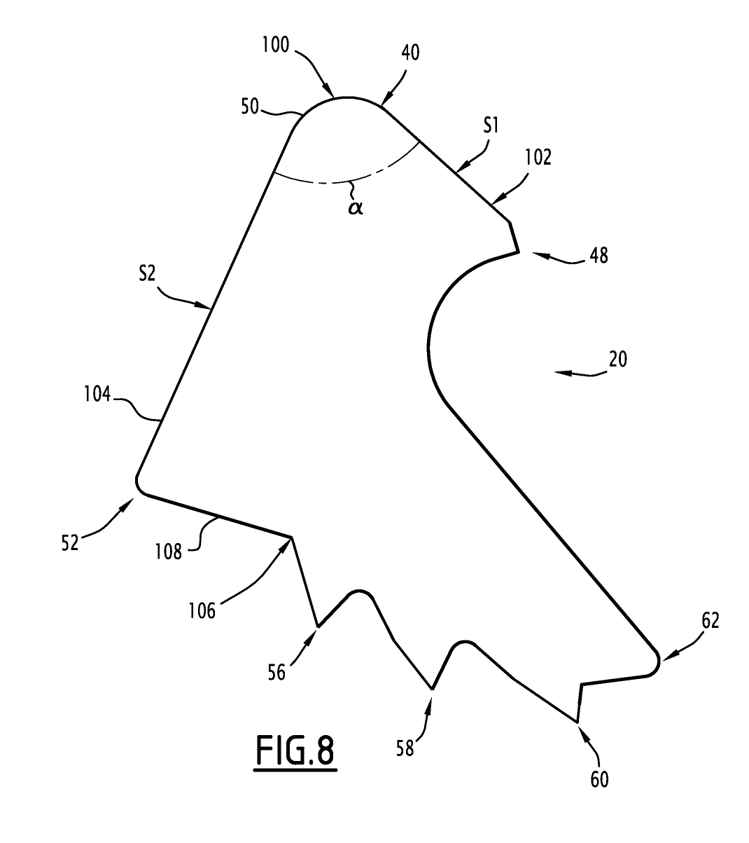

FIG. 8 is a meridian view of the locking insert of the assembly of FIGS. 1 to 7;

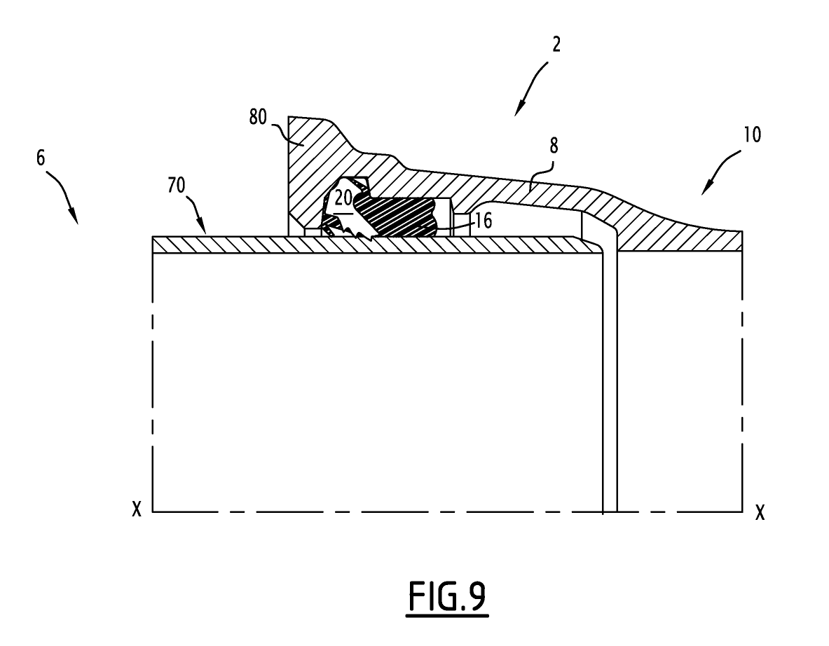

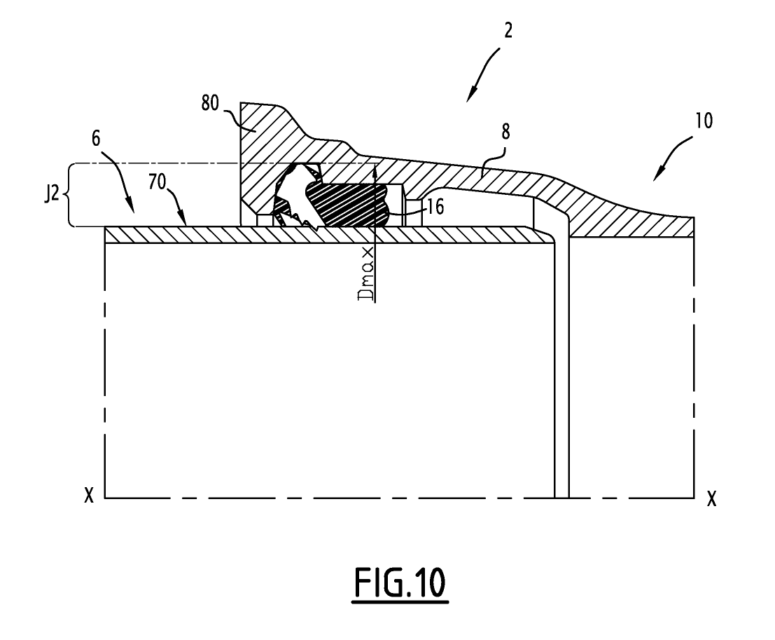

FIGS. 9 and 10 are meridian cross-sectional half-views of an assembly of two pipes and a composite sealing gasket inserted between them after production of the locked assembly according to one alternative of the invention; and

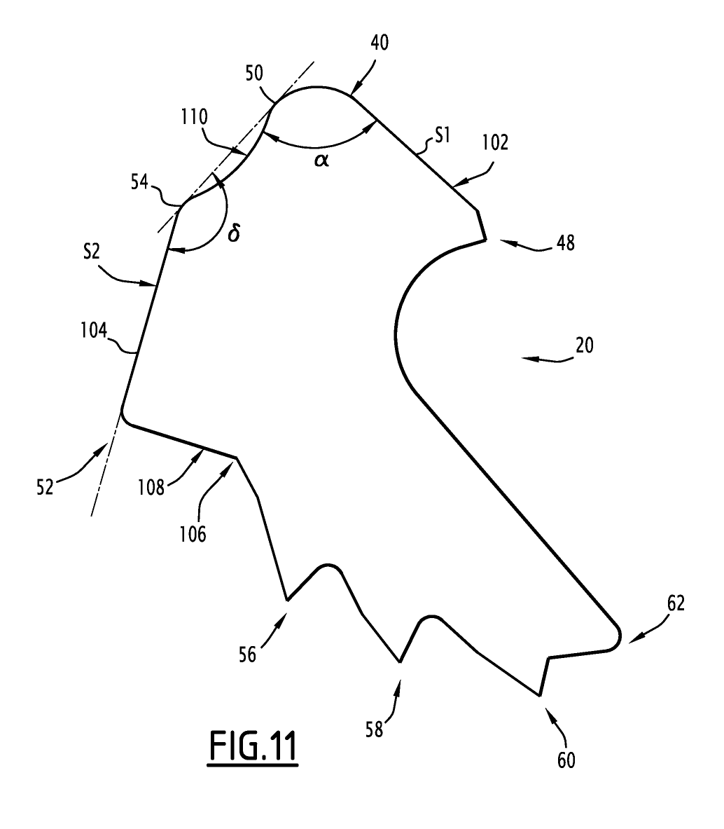

FIG. 11 is a meridian view of a locking insert according to the alternative of the invention shown in FIGS. 9 and 10.

FIGS. 1 to 3 show a sealed and locked assembly according to the invention, designated by general reference 2.

The sealed assembly 2 comprises a spigot 4 or male end secured to a first pipe 6, a socket 8 or female end secured to a second pipe 10, and a sealing gasket 12.

The assembly 2 extends along a central axis X-X. Hereafter, the expressions “radially,” “axially,” “circumferentially” and “meridian” will be used relative to that axis.

The sealing gasket 12 includes, in meridian cross-section, an elastic ring 14 made from a flexible or resilient material, for example made from an elastomer, that extends along the central axis X-X, in which a plurality of locking inserts 20 are embedded.

The elastic ring 14 comprises an annular solid body 16 toward the bottom of the socket as well as, on the inlet side of the socket, an anchoring heel 18 protruding radially outward and a circular sealing lip 26 protruding radially inward.

The body 16 and the heel 18 are separated by a peripheral shoulder 22.

The lip 26 extends substantially radially toward the axis X-X as far as the vicinity of the minimum inner diameter of the body 16. The inserts 20 are regularly distributed over the entire perimeter of the ring 14. Each locking insert 20 is made from a very hard material, for example a hard metal alloy or ceramic.

Each insert 20 comprises, in meridian view, a radially outer head 30 and a radially inner foot 32. The head 30 extends substantially radially relative to the axis X-X, while the foot 32 is inclined relative to that axis, such that it converges toward the axis X-X in an insertion direction I of the spigot 4 into the socket 8. The insert 20 thus has a curved profile.

Each insert 20 is partially embedded in the anchoring heel 18 of the gasket 12 and partially covered by the elastic material of the heel 18. However, the heel 18 includes recesses 36 at the inserts 20. The recesses 36 are radially outwardly open, such that the radially outer end of the head 30 is practically free from elastic. The recesses 36 are also axially open in the insertion direction I.

Likewise, the sealing gasket 12 comprises recesses 38, open radially inwardly, and situated at the location of the inserts 20, such that the radially inner end of the feet 32 is free from elastic material.

As shown more precisely in FIG. 6, the head 30 comprises, at the radially outer end thereof, a profile forming a radial projection 40. The head 30 also comprises a retaining nose 48 with a sharp edge oriented axially in the direction I. The nose 48 is practically free from elastic material owing to the recess 36.

The head 30 also comprises an inclined projection 50, extending obliquely relative to the central axis X-X.

In the case at hand, the two projections 40, 50 are formed by an arc-of-circle-shaped profile of the locking insert, in meridian view.

The head 30 also comprises a frontal projection 52 that is radially offset from the inclined projection 50 toward the axis X-X.

A substantially planar surface S1 extends between the radial projection 40 and the retaining nose 48, and a substantially planar surface S2 extends between the two inclined 50 and frontal 52 projections. These surfaces S1, S2 form an angle a smaller than 90° between them.

Furthermore, the foot 32 comprises, at the radially inner end thereof, three catching teeth 56, 58, 60 that are axially offset and that are designed to catch on the outer surface 70 of the spigot 4 (see below) and which, when the gasket is idle, extend outside the elastic ring 14. In meridian view, the teeth 56, 58, 60 extend over a convex curve. Furthermore, the foot 32 includes, on the axial side opposite the head 30, a catching stop 62 embedded in the body 16. The catching stop 62 has, in meridian view, a profile that is rounded relative to the profile of the catching teeth 56, 58, 60.

The stop 62, the function of which is to limit the penetration of the insert 20 in the spigot 4 so as not to deteriorate the latter, preferably has a rounded or curved shape so as to favor the “flow” of the elastomer during fitting of the spigot 4, so as to avoid stress concentrations that could cause tears in the elastomer.

In reference again to FIG. 1, it is shown that the spigot 4 comprises a cylindrical outer surface 70 with a diameter d provided with an inlet bevel 72. The spigot 4 is manufactured with diametric allowances such that the actual diameter d can be situated between a maximum outer diameter dₘₐₓ and a minimum outer diameter dₘᵢₙ. The diameters dₘₐₓ and dₘᵢₙ are indicated in mixed lines in FIG. 1.

The spigot 8 successively includes, axially from the inlet of the fitting toward the bottom, an inlet flange 80, an annular anchoring groove 82 serving as a housing for the anchoring heel 18 of the gasket, a stepped part 84, an inner bead 86, and a receiving cavity 88, designed to freely receive the end of the spigot 4.

The inlet flange 80 defines an inlet surface 81, which is a cylindrical surface with diameter DISE (cf. FIG. 4).

The annular anchoring groove 82 is delimited by an annular frontal surface 90 of the inlet flange 80, an inclined surface 91, a cylindrical bottom surface 92 with a circular cross-section with axis X-X, and a frontal surface 94 of the stepped part 84.

In general, the frontal surface 90 extends over an angle of at least 80° relative to the central axis X-X and has an axial component oriented in direction I. Preferably, the frontal surface 90 forms an angle of at least 85° with the axis X-X. The frontal surface 90 extends from the inlet surface 81 to the inclined surface 91.

The inclined surface 91 extends over an angle comprised between 30° and 60° relative to the central axis X-X and has an axial component oriented in the direction I. The inclined surface 91 is therefore positioned radially and axially between the bottom surface 92 and the frontal surface 90.

Furthermore, the annular frontal surface 90 connects directly to the inclined surface 91, which in turn connects directly to the bottom surface 92. In meridian view, the annular frontal surface 90 connects to the inclined surface 91 at the connecting point PR. This connecting point PR is situated at a distance DPRSE from the inlet surface 81, that distance being comprised between 10% and 90% of the difference between the diameter of the inlet surface DISE and the diameter D of the bottom surface 92. Preferably, the distance DPRSE is comprised between 40% and 60% of said difference or between 45% and 55% of said difference.

The angle y included by the frontal 90 and inclined 91 surfaces is smaller than 180°, and is in particular comprised between 110° and 160°.

For any play between the surfaces 70 and 92 comprised in the acceptable allowance range, the insert 20 presses both on the one hand against the bottom surface 92 and on the other hand against the inclined surface 91, and/or against the frontal surface 90 when the pipes are subjected to the internal pressure of the fluid they convey.

More specifically, for a given position, when the play between the surfaces 70 and 92 is in a first play range delimited by the minimum play J1 (FIGS. 4 and 5) and an intermediate play, the locking insert 20 presses against the bottom surface 92 and the inclined surface 91 when the pressure is established, but does not press against the frontal surface 90.

When the play between the surfaces 70 and 92 is situated in a second play range, delimited by the maximum play J2 (FIGS. 6 and 7) and the intermediate play, the locking insert 20 presses against the bottom surface 92 and the frontal surface 90 when the pressure is established, but not against the inclined surface 91. It should be noted in this case that, when the pressure is established and before reaching the said final bearing configuration, the insert 20 first goes through a configuration in which it presses against the bottom surface 92 and the inclined surface 91, then through an intermediate configuration in which it presses simultaneously against the bottom surface 92, the inclined surface 91 and the frontal surface 90.

The frontal surface 94 is oriented toward the inlet flange 80, against the direction I.

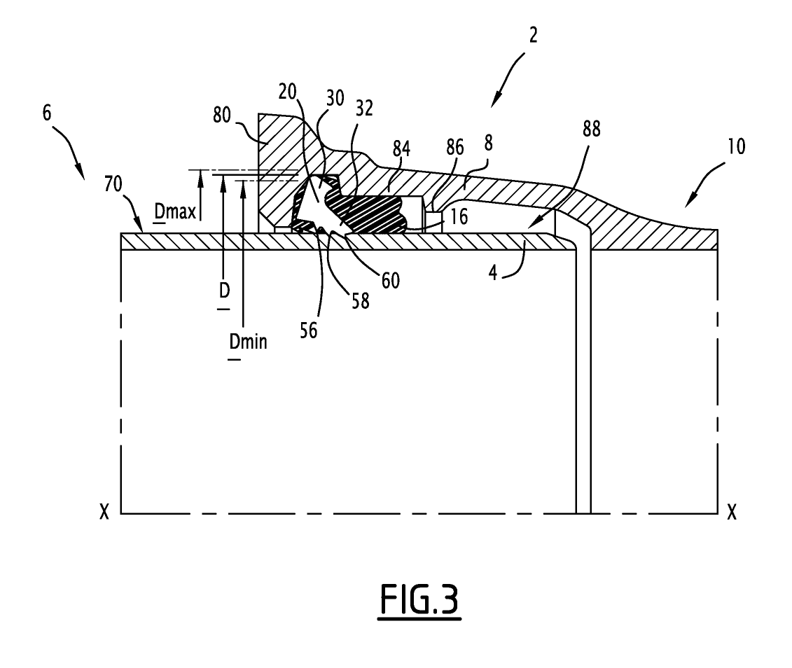

As indicated in FIG. 3, the bottom surface 92 is also subject to manufacturing allowances, such that its actual diameter D can vary between a maximum diameter Dₘₐₓ and a minimum diameter Dₘᵢₙ.

It should be noted that the maximum diameter dₘₐₓ of the surface 70 is smaller than the diameter DISE of the surface 81.

The assembly according to the invention is assembled as follows.

The sealing gasket 12 is first inserted into the socket 8, the body 16 pressing against the stepped part 84 and the anchoring heel 18 being placed in the annular anchoring groove 82, such that the axis of the gasket 12 is combined with that of the socket.

Then, the spigot 4 is aligned with the socket and is inserted through the gasket 12 in the direction I while first folding the lip 26, which presses with some pressure against the outer surface 70. When the spigot 4 crosses the threshold of the inserts 20, the latter parts become inclined through regular travel against the body 16. The insertion of the spigot 4 continues until its bevel 72 arrives near the bottom of the cavity 88.

The spigot 4 is then axially brought backwards so as to brush the inserts 20 back up. The inserts 20 modify their incline relative to the axis X-X through an inverse travel opposite the preceding travel and with a small amplitude. During this brushing up, at least one of the teeth 56, 58, 60 catches on the outer surface 70 of the spigot 4 and then offers significant resistance to the continuation of the axial removal movement of the spigot 4. The assembly is thus locked.

Subsequently, in reference to FIGS. 4 to 7, the operation of the sealing gasket according to the invention will be described as a function of the diametric allowances on the diameters d and D under the action of pressurized fluid. In these Figures, the ring 14 has been omitted for better clarity of the drawing.

After the aforementioned angular travel of the inserts 20 during the assembly of the pipes 6 and 10, each insert 20 assumes an inclined position that varies as a function of the play present between the diameters d and D.

FIG. 4 shows the position of an insert 20 during catching on the spigot 4 during pressurization in the case where the play between the pipes is a minimum play J1. To that end, the socket 8 comprises an anchoring groove 82 whereof the diameter D corresponds to the minimum diameter Dₘᵢₙ, while the spigot 4 has a surface 70 whereof the outer diameter corresponds to the maximum diameter dₘₐₓ. The two diameters Dₘᵢₙ and dₘₐₓ thus define a minimum play J1 between the two surfaces 92 and 70.

One can see that, during catching on the spigot 4, the insert 20 presses against the groove 82 in two places, on the one hand with its radial projection 40 against the bottom surface 92 and on the other hand with its inclined projection 50 against the inclined surface 91. Furthermore, only the catching tooth 56 closest to the fitting inlet presses against the outer surface 70 of the spigot.

The insert 20 is inclined by a reaction angle that is defined as follows. In meridian view, the two lines L1, L2 that extend perpendicular to the surfaces 92, 91 at the respective projections 40, 50 for pressing the insert 20 against the groove 82 intersect at a point P. The pressing point of the tooth 56 on the surface 70 defines, with the point P, a third line L3 serving as a support for the reaction force of the insert 20. The angle β1 measured between said line L3 and a plane perpendicular to the axis X-X is called the catching “reaction angle.”

The catching of the insert 20 is better when this reaction angle is low. Owing to the presence of the radial projection 40 and the inclined surface 91, the point P is located in a position that is axially relatively close to the tooth 56, such that the angle β1 is small for the given play J1, which favors catching of the locking insert 20 on the surface 70.

FIG. 5 shows the part of the assembly of FIG. 4 when the pressure is established.

One can see that, after catching of the insert 20, the latter has tilted in the clockwise position relative to FIG. 4, and the three catching teeth 56, 58, 60 now penetrate the material of the spigot 4.

As before, the locking insert 20 presses, by its radial projection 40, against the bottom surface 92, and by its projection 50 against the inclined surface 91.

The point P is once again the point of intersection of the lines L1, L2 of the normals to the surfaces 92, 91 at the projections 40, 50. Conversely, the assembly defines a line L3, which extends between the point P and a point M situated substantially axially midway between the catching teeth 56 and 60.

The line L3 defines, with a plane perpendicular to the axis X-X, a reaction angle β1 under established pressure that is thus relatively large for the given play J1, which leads to good pressure resistance of the locked assembly.

It should be noted that, during tilting of the insert 20 when the pressure is being established, the maintenance of contact at the radial projection 40 as well as the catching of axially offset teeth in the direction I of the tooth 56 closest to the fitting inlet makes it possible to increase the reaction angle and, inter alia, to thereby offset the decreased reaction angle resulting from the tilting of the insert in the clockwise direction; this thereby results in a large enough angle β2 to guarantee good pressure resistance.

In the case of minimum play J1, the front projection 52 is out of contact with the front surface 90 both during the insertion of the spigot 4 into the socket 8 and during and after the establishment of pressure.

The explanations relative to FIGS. 4 and 5 are valid for any play comprised in the first play range.

FIG. 6 shows an assembly similar to that of FIG. 4, with the following differences.

The surface 92 has a diameter Dₘₐₓ, while the surface 70 has a diameter dₘᵢₙ, such that these two surfaces define a play J2 between them that is larger than the play J1. This play J2 is the maximum acceptable play for the manufacturing allowances of the spigot 4 and the socket 8.

One can see that, upon catching on the spigot 4, during the pressurization, the insert 20 presses against the groove 82 in two places, on the one hand with its radial projection 40 against the bottom surface 92 and on the other hand with its inclined projection 50 against the inclined surface 91. The frontal projection 52 is out of contact with the frontal surface 90. Furthermore, only the catching tooth 60 furthest from the fitting inlet presses against the outer surface 70 of the spigot.

The catching reaction angle β3 obtained is measured between the radial direction and a line passing through the point P, substantially identical to that of the assembly of FIG. 5, and by the point of contact between the surface 70 and the tooth 60. This angle β3 is small and therefore compatible with good catching of the insert 20.

FIG. 7 shows the assembly of FIG. 6 once the pressure is established, therefore after catching of the insert 20 and after tilting thereof in the clockwise direction in the Figures.

At the end of that tilting, the insert 20 presses only with its radial projection 40 against the bottom surface 92 and only with its frontal projection 52 against the frontal surface 90, while the other projection 50 is out of contact with the surface 91. Furthermore, only the intermediate teeth 58 and the tooth 60 furthest from the fitting inlet catch in the surface 70 of the spigot 4.

With maximum play J2, the contact at the frontal projection 52 increases the reaction angle and offsets the reaction angle resulting from the tilting of the insert in the clockwise direction during pressurization. This thus makes it possible to obtain, owing to this projection 52 that generates a point P situated near the axis X-X, a final established pressure reaction angle β4 that is large enough to guarantee good pressure resistance of the locked assembly.

The explanations in reference to FIGS. 6 and 7 are valid for any play comprised in the second play range.

For all acceptable plays between the surfaces 70 and 92, the insert 20 presses, in meridian view, against the bottom surface 92, the inclined surface 91 and/or the front surface 90 in each contact location, according to a periodic and nonlinear contact. Thus, the manufacturing allowances of the insert and the surfaces 90, 91, 92 may be significant.

FIG. 8 shows the insert 20 on a larger scale.

The following explanations refer to the meridian, therefore side, view of the locking insert 20.

The locking insert 20 includes an arc-of-circle-shaped rounded profile 100, which forms the projections 40 and 50. This rounded profile 100 extends over an angular range greater than 90°.

A rectilinear profile 102 extends between the rounded profile 100 and the catching nose 48. This profile 102 connects tangentially to the profile 100 and forms the surface S1.

Between the rounded profile 100, or the inclined projection 50, and the frontal projection 52, another rectilinear profile 104 extends. This profile 104 is tangentially connected to the profile 100 and forms the surface S2.

The frontal projection 52 is formed by a rounded profile, preferably in an arc-of-circle shape, extending over an angular range greater than 90°.

The frontal projection 52 and the catching tooth 56 are connected by a concave profile 106. This concave profile 106 constitutes the passage for the tooth 56 and comprises a rectilinear partial profile 108 that extends from the frontal projection 52.

FIGS. 9 to 11 show one alternative of the invention, which differs from the embodiment above only as follows. Similar elements bear identical references.

FIG. 9 shows the assembly with average play.

FIG. 10 shows the assembly with maximum play J2.

The locking insert 20 includes a second inclined projection 54, radially offset from the first inclined projection 50. This inclined projection 54 is designed to press against the inclined surface 91 of the anchoring groove.

In meridian view, therefore in side view, a rectilinear profile 104 extends between the frontal projection 52 and the second inclined projection 54, while the second inclined projection 54 and the first inclined projection 50 are separated by a concave profile 110. The straight line that connects the two inclined projections 50, 54 forms, with the rectilinear profile, an angle δ that is different from the angle y between the two frontal 90 and inclined 91 surfaces, and preferably smaller than that angle. Thus, the number and expanse of the contact locations between the locking insert 20 and the surfaces 90, 91 are small.

The angle δ is smaller than 180°.

Furthermore, the concave profile 110 helps minimize the contact locations between the locking insert 20 and the inclined surface 91.

In an alternative not shown, the two inclined projections 50, 54 are separated by a rectilinear profile.

Also in an alternative not shown, the frontal projection 52 and the inclined projection adjacent to the frontal projection, which is the projection 54 in FIG. 11, are connected by a concave profile.

Owing to the geometric characteristics of the inserts 20 and the surfaces 90, 91, the sealing gasket leads to a good compromise between the catching of the inserts on the spigot and pressure resistance, independently of the actual play existing between the surfaces 70 and 92.

Furthermore, the recesses 36 make the bearing of the inserts 20 toward the minimum plays more reliable, by reducing the fitting force of the spigot 4 and avoiding compression stresses in the elastomer that can cause poor positioning of the inserts 20 by tilting in a direction tending to increase the reaction angle (and therefore harm the proper catching of the inserts 20 with minimal play). Furthermore, the recesses 36 facilitate the overall deformation of the ring 14 during its placement of the gasket in the socket.

The invention may also include the following features:
The foot 32 includes a catching stop 62 that is embedded in the body 16 and that is positioned on the side axially opposite the head 30.
The catching stop 62, in meridian cross-section along the central axis X-X, has a more rounded profile than the profile of the catching teeth 56, 58, 60.
The ring 14 comprises at least one recess 36 at a locking insert 20, and the recess 36 is radially outwardly open such that a radial end of the head 30 is practically free from elastic.
The catching teeth extend outside the ring 14.
The head 30 of each locking insert 20 comprises a retaining nose 48 oriented axially opposite the first inclined projection 50, and the recess 36 is axially open such that the retaining nose 48 is practically free from elastic material.
The anchoring heel 18 and the body 16 are separated by at least one hollow, in particular a peripheral groove or recesses circumferentially aligned with the inserts 20.
The frontal surface 90 is on the inlet side of the socket.

1. A sealed and locked assembly, of the type comprising a spigot (4) of a first pipe element, a socket (8) of a second pipe element, and a composite sealing gasket (12) for the sealed and locked assembly between the spigot (4) and the socket (8), the sealing gasket comprising a ring (14) made from an elastic material that extends along the central axis (XX), and which has a body (16) and an anchoring heel (18) on the one hand, and at least one locking insert (20) at least partially embedded in the anchoring heel (18) on the other hand,
the socket comprising an annular anchoring groove (82), the anchoring groove (82) being defined by an inclined surface (91) positioned axially and radially between a bottom surface (92) and an annular frontal surface (90),
the locking insert comprising
a head (30) suitable for being inserted into the anchoring groove (82) of the socket, and a foot (32),
the head (30) including a radial projection (40), designed to press against the bottom surface (92) of the anchoring groove (82) of the socket and a first inclined projection (50), suitable for pressing against the inclined surface (91) of the anchoring groove (82),
characterized in that the head (30) comprises at least one frontal projection (52) that is offset, in particular radially offset, from the first inclined projection (50) and designed to press against the annular frontal surface (90) of the anchoring groove (82), the annular frontal surface (90) and the inclined surface (91) forming an angle (γ) smaller than 180° between them.

2. The assembly according to claim 1, characterized in that the head (30) comprises at least one second inclined projection (54), which is offset, in particular radially offset, from the first inclined projection (50) and the frontal projection (52) and designed to press against the inclined surface (91) of the anchoring groove (82).

3. The assembly according to claim 2, characterized in that the first and second inclined projections (50, 54) are, in side view, connected by a concave or rectilinear profile (110).

4. The assembly according to claim 1, characterized in that the frontal projection (52) and the inclined projection adjacent to the frontal projection (52) are, in side view, connected by a concave or rectilinear profile (104).

5. The assembly according to claim 1, characterized in that in side view, the foot (32) of the insert comprises at least one catching tooth (56, 58, 60) adapted to catch on an outer surface (70) of the spigot (4).

6. The assembly according to claim 5, characterized in that the frontal projection (52) and the closest catching tooth (56) are, in side view, made by a concave or rectilinear profile (106).

7. The assembly according to claim 1, characterized in that in side view, the head (30) includes a catching nose (48), a first straight line extending from the radial projection (40) toward the catching nose and a second straight line connecting the frontal projection (52) to the first inclined projection (50), and in that the angle (α) between said two straight lines is comprised between 60° and 120° and preferably smaller than 90°.

8. The assembly according to claim 1, characterized in that the head (30) is a radially outer head, at least partially embedded in the anchoring heel (18) and designed to press in the anchoring groove (82) of the socket (8), and in that the foot is a radially inner foot (32), designed to press against the spigot (4).

9. The assembly according to claim 1, characterized in that the bottom surface (92) that defines the annular anchoring groove (82) is a cylindrical surface, in particular extending coaxially relative to the central axis (X-X), and the annular frontal surface (90) is formed by an inlet flange (80) of the socket (8), the annular frontal surface (90) extending over an angle of at least 80° relative to the central axis (X-X).

10. The assembly according to claim 9, characterized in that the inclined surface (91) has an incline comprised between 30° and 60° relative to the central axis (X-X).

11. The assembly according to claim 10, characterized in that all of the projections (40, 50, 52) are arranged such that for any diameter of the bottom surface (92) of the socket and the outer surface (70) of the spigot comprised in an allowance range and in a meridian cross-sectional view, the locking insert (20) bears at the same time on at most three or two locations of the anchoring groove (82) of the socket.
